(19) United States
(12) Patent Application Publication
(10) Pub. No.: US 2020/0103541 A1
(43) Pub. Date: Apr. 2, 2020

(54) VALIDATING LATERAL ELASTIC PROPERTIES VALUES ALONG LATERAL WELLS

(71) Applicant: CGG SERVICES SAS, Massy Cedex (FR)

(72) Inventors: Ahmed MOHAMED, Houston, TX (US); Chi Vinh LY, Houston, TX (US)

(21) Appl. No.: 16/396,892

(22) Filed: Apr. 29, 2019

Related U.S. Application Data
(60) Provisional application No. 62/740,026, filed on Oct. 2, 2018.

(51) Int. Cl. G01V 1/28; E21B 49/00; G01V 1/30

(52) U.S. Cl. CPC G01V 1/282; G01V 2210/6169; G01V 1/301; E21B 49/00

(57) ABSTRACT

A seismic exploration method used lateral well data to validate lateral elastic properties values. The validated lateral elastic properties values are obtained by generating a constrained 3D rock facies model using the lateral and vertical well data and the seismic inversion results, cross-correlating synthetic lateral elastic properties values for locations along the lateral well, based on the lateral and vertical well data with the seismic inversion results to obtain calibrated synthetic lateral elastic properties values, and adjusting the calibrated synthetic lateral elastic properties values according to the constrained 3D rock facies model.

### BACKGROUND

### Technical Field

Embodiments of the subject matter disclosed herein generally relate to methods and systems for geological exploration, and, in particular, to methods and systems for validating lateral elastic properties values, with such structural knowledge being used in fracking-related decisions.

### Discussion Of The Background

Lateral (also known as “horizontal”) wells have proven particularly useful in hydraulic fracking for extracting oil and gas from low permeable geologic formations (LPGF). Fracking techniques fracture the rock, creating openings through which hydrocarbon flows. The rock is fractured by pumping a fluid compound (e.g., made of water, chemicals and guar gum, also known as “mud”) into sections (known as “stages”) of lateral wells.

FIG. 1 illustrates a well including a borehole 101 between a well head 110 and a landing point 120, and a lateral well 102 between landing point 120 and a well bottom 130. Lateral wells are dug using a directional drilling technique at drilling angles of at least 80° to the vertical direction. In FIG. 1, the vertical direction is a virtual line between well head 110 and a point 111, which is vertically beneath the well head. Lateral well's length (LL) between landing point 120 and well bottom 130 may be larger than the borehole's length.

The underground structures through which boreholes are drilled are made of rock facies, which are volumes with a same value for any attribute throughout. Here, an attribute is any property that characterizes a solid material. For example, attributes are mechanical properties (e.g., elastic properties such as acoustic impedance, ratio of compressional and shear wave-propagation velocities, Vp/Vs, porosity), lithology characteristics visible in core samples (e.g., color, texture, grain size, mineral composition), electrical properties, etc.

Seismic surveys are performed over hydrocarbon-rich formations to acquire seismic data carrying structural information. An inversion process applied to the seismic data yields or improves a model of the subsurface structure and estimated attribute values (e.g., elastic properties). The inversion results may be constrained to be consistent with attribute values obtained from vertical well log data and sample analysis. The seismic inversion may simultaneously yield plural elastic properties (e.g., P-impedance, S-impedance and density) values and may reconstruct both the overall structure and the fine structural details. Note that impedance is the product of density and wave propagation velocity, P-impedance referring to the faster primary compressional waves and S-impedance referring to secondary shear waves.

Conventional inversion workflows use vertical well data to guide the inversion process. Therefore, the elastic properties values resulting from the seismic inversion closely correlate with corresponding measured or inferred values at vertical well(s) locations. The geological rock facies are then defined based on a series of cutoffs using the mineral and fluid volumes calculated in a petrophysical evaluation. Location and nature of the rock facies are calibrated with core data in order to discriminate the petrophysical properties of interest in elastic space (e.g., P-impedance vs Vp/Vs).

The calibrated rock facies are then used along with inverted elastic attribute values and Bayesian inference to separate the rock facies and create probability volumes. A further quality assurance and control may be completed by testing the predicted seismic facies against blind vertical wells. The article by R. J. Michelena et al 2017, “Integrated facies modeling in unconventional reservoirs using a frequentist approach: Example from a South Texas field,” Geophysics 82, B219-6230 describes a workflow using stochastic facies modelling using log data along horizontal wells.

A limitation of conventional inversion workflows is the inability to validate the seismic facies between the vertical wells. Denser and denser vertical wells are needed to decrease the uncertainly in the attribute values predicted by conventional inversion workflows.

In the context of increasing popularity and volume of fracking, there have been efforts to better understand elastic properties along the lateral wells using techniques ranging from traditional logging (which is both costly and risky) to in-bit measurement tools, computer learning modeling of drilling data/parameters and drilling cuttings' synthetic elastic properties. However, aside from direct wireline logging, all these other techniques lack a mechanism to calibrate/validate along the lateral well, therefore being assumed that the lateral well response conforms to the calibrated model (be it a rock-driven or computer drilling data-driven model). Reality has often contradicted this assumption. Thus, there is a need to propose methods and systems that overcome the above-described drawbacks and limitations of existing methods.

### SUMMARY

Methods and devices according to various embodiments include validation of lateral elastic properties using lateral well data in a seismic inversion workflow.

According to an embodiment there is a seismic exploration method including (A) obtaining lateral and vertical well data related to a lateral well and at least one vertical well through a subsurface formation, and seismic inversion results for seismic data acquired during a seismic survey over the subsurface formation, (B) generating a constrained 3D rock facies model using the lateral and vertical well data and the seismic inversion results, (C) cross-correlating synthetic lateral elastic properties values for locations along the lateral well, based on the lateral and vertical well data with the seismic inversion results to obtain calibrated synthetic lateral elastic properties values, and (D) adjusting the calibrated synthetic lateral elastic properties values according to the constrained 3D rock facies model. The calibrated lateral elastic properties values validated by matching the constrained 3D rock facies model are usable in fracking-related decisions.

According to another embodiment there is a seismic data processing apparatus having an interface and a data processing unit connected to the interface. The interface is configured to obtain lateral and vertical well data related to lateral and vertical wells through a subsurface formation, and seismic inversion results for seismic data acquired during a seismic survey over the subsurface formation. The data processing unit is configured to generate a constrained 3D rock facies model using the lateral and vertical well data and the seismic inversion results, to cross-correlate synthetic lateral elastic properties values based on the lateral and vertical well data with the seismic inversion results to obtain calibrated synthetic lateral elastic properties values, and to adjust the calibrated synthetic lateral elastic properties values according to the constrained 3D rock facies model.

According to yet another embodiment, there is a computer readable medium storing executable codes that, when executed by a computer make the computer perform seismic exploration method. The seismic exploration method includes (A) obtaining lateral and vertical well data related to a lateral well and at least one vertical well through a subsurface formation, and seismic inversion results for seismic data acquired during a seismic survey over the subsurface formation, (B) generating a constrained 3D rock facies model using the lateral and vertical well data and the seismic inversion results, (C) cross-correlating synthetic lateral elastic properties values for locations along the lateral well, based on the lateral and vertical well data with the seismic inversion results to obtain calibrated synthetic lateral elastic properties values, and (D) adjusting the calibrated synthetic lateral elastic properties values according to the constrained 3D rock facies model.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic representation of a lateral well;

FIG. 2 is a block diagram of a seismic exploration method according to an embodiment;

FIG. 3 is a dataflow according to an embodiment;

FIG. 4 is a graphical representation of a lateral well in a subsurface formation;

FIG. 5 is an illustration of validated lithology results for a lateral well and its surrounding area;

FIG. 6 is an illustration of validated P-impedance values for a lateral well and its surrounding area;

FIG. 7 is an illustration of validated Young Modulus values for a lateral well and its surrounding area;

FIG. 8 is an illustration of validated quartz distribution for a lateral well and its surrounding area;

FIG. 9 is an illustration of validated Kerogen distribution for a lateral well and its surrounding area;

FIG. 10 is a flowchart of a method according to an embodiment; and

FIG. 11 is a block diagram schematically illustrating a seismic data processing apparatus according to an embodiment.

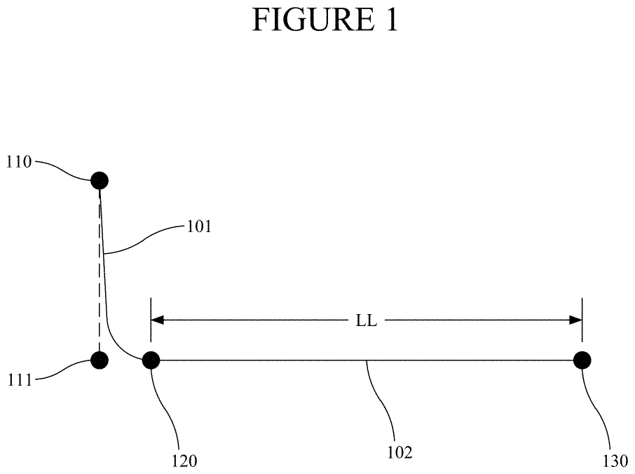

### DETAILED DESCRIPTION

The following description of the exemplary embodiments refers to the accompanying drawings. The same reference numbers in different drawings identify the same or similar elements. The following detailed description does not limit the invention. Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places is not necessarily referring to the same embodiment. Further, the particular features, structures or characteristics may be combined in any suitable manner in one or more embodiments.

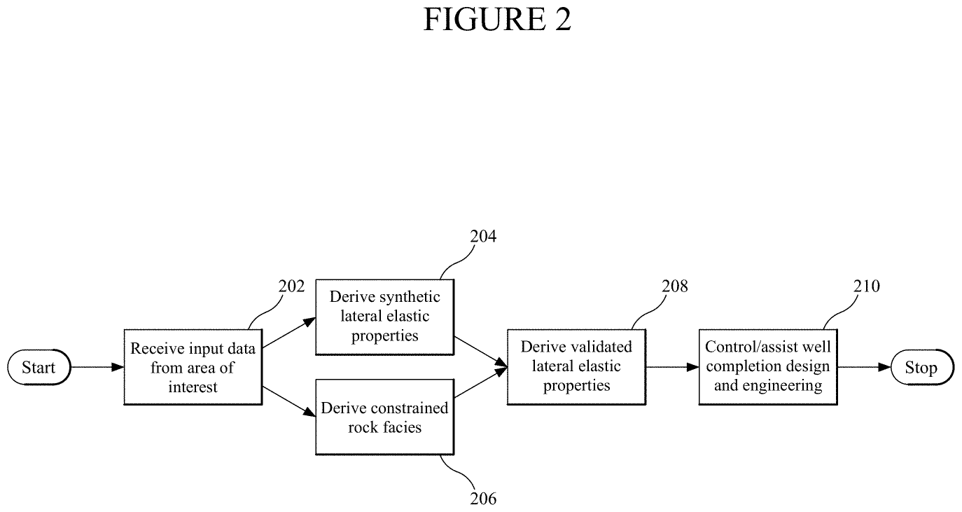

Embodiments described hereinafter use lateral well data to attain a more accurate calibration and validation of lateral well-related attribute values estimated by seismic inversion previously guided (or constrained) by vertical well log data. FIG. 2 is a block diagram representing a seismic exploration method according to an embodiment.

Input data from the area of interest is received at 202. The input data includes vertical well log data, lateral well data (including drilling, core data, geological data, etc.) as well as seismic inversion results. At 204, synthetic lateral elastic properties values are derived using the vertical well log data and the lateral well data. At 206, the lateral well data, vertical well log data and seismic inversion results are used to derive a constrained rock facies model. A set of validated lateral elastic properties values are derived at 208 by comparing and adjusting the synthetic elastic properties values with values derived using the constrained rock facies model obtained at 206. The validated-lateral-elastic-properties values are used to control and assist in well completion design and well engineering (e.g., stages placement) at 210.

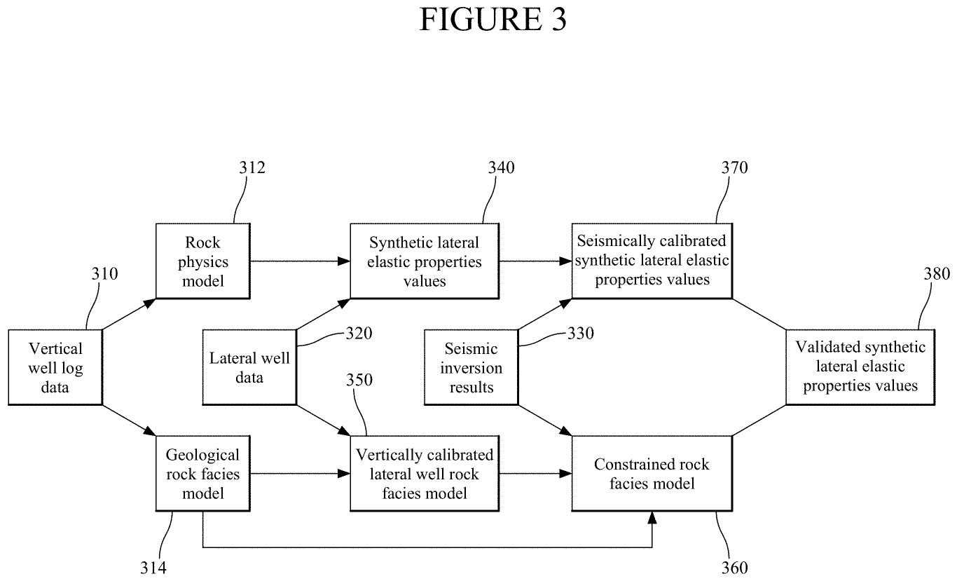

FIG. 3 is a data flow according to an embodiment. Vertical well log data 310, lateral well data 320 and seismic inversion results 330 are the input information. Vertical well log data 310 is used to derive a rock physics model 312 and a geological rock facies model 314. Rock physics model 312 is generated such that synthetic elastic properties values based on this model closely match measurements in vertical well log data 310. Lateral well data 320 may include geological material, drilling data, lateral core cuttings and mechanical properties. The seismic inversion results 330 are extracted from the seismic data acquired over the area of interest.

Elastic properties values along a lateral well (i.e., synthetic lateral elastic properties values 340) are synthesized using rock physics model 312 and lateral well data 320. Geological rock facies model 314 and lateral well data 320 are used to generate a vertically calibrated lateral well rock facies model 350. Geological rock facies model 314 cross-correlated with vertically calibrated lateral well rock facies model 350 is used in combination with seismic inversion results 330 to obtain a constrained 3D rock facies model 360.

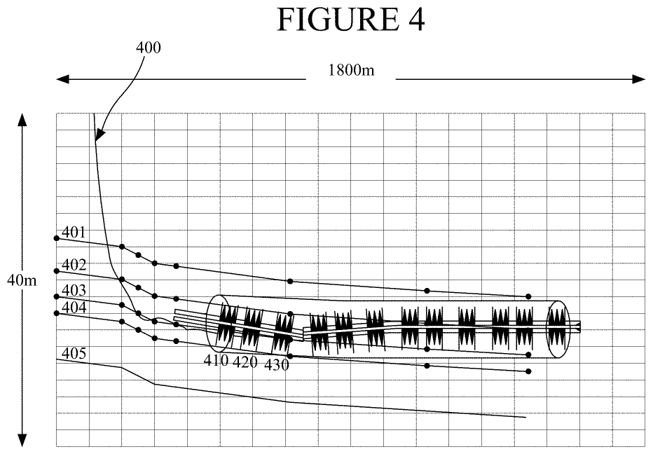

Synthetic lateral elastic properties values 340 are cross-correlated with seismic inversion results 330 and adjusted to obtain seismically calibrated synthetic lateral elastic properties values 370. This cross-correlation is complicated when seismic inversion results are 2D or 3D, whereas the well elastic properties values correspond to 1D. Therefore, a step of extrapolating the 1D well information into a 2D/3D surface or volume is required for enabling the cross-correlation. The extrapolation is achieved by creating a virtual 2D surface or 3D cylinder that encompasses the area/surfaces of the lateral well of interest as shown in FIG. 4 discussed later.

These seismically calibrated synthetic lateral elastic property values 370 are then adjusted to match the constrained rock facies model 360 yielding validated-synthetic-lateral-elastic-properties values 380. In other words, the seismically calibrated synthetic lateral elastic property values are validated using the constrained 3D rock facies model.

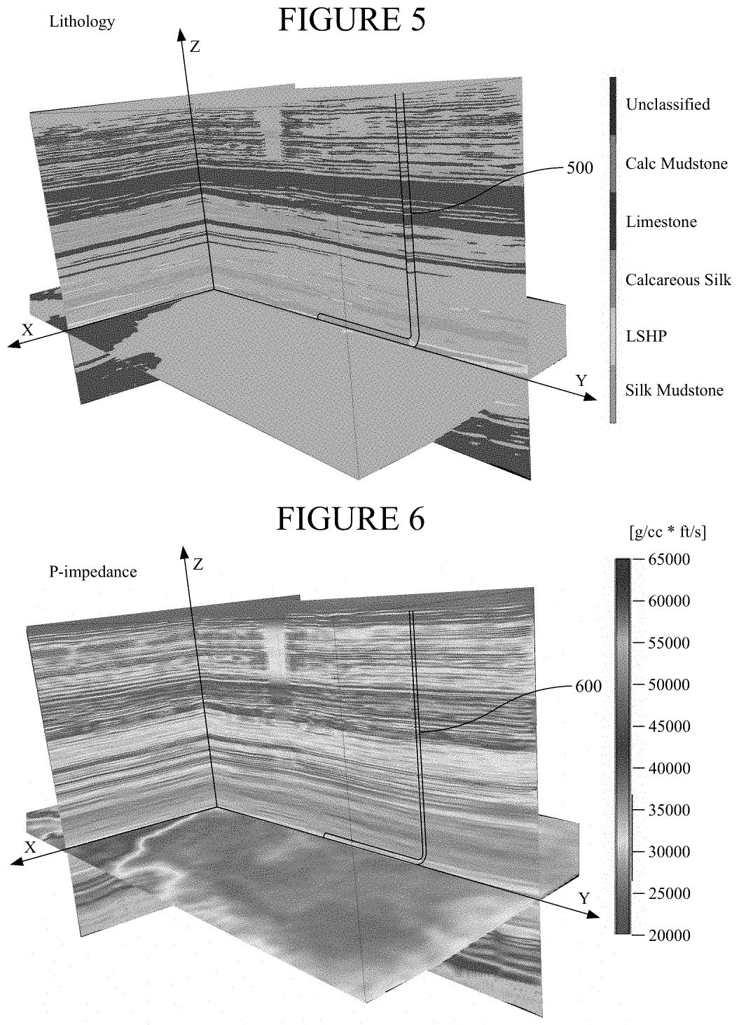

These validated-synthetic-lateral-elastic-properties values 380 (illustrated in FIGS. 5-9) are usable in fracking-related decisions such as well completion design and well engineering (e.g., placement of stages along the lateral well).

FIG. 4 is a graphical representation of a lateral well 400 within 1800 m horizontal distance and 40 m depth in a subsurface formation. Lines 401-405 signify limits between different rock facies. The cylinder surrounding the lateral well illustrates the transition from 1D to 2D or 3D evaluations of elastic properties values. Stage placement (see stages 410, 420, 430 etc. not all stages illustrated in FIG. 4 being labeled) may be selected between a top perforation and a bottom perforation using the validated-synthetic-lateral-elastic-properties set of values.

FIG. 5 is an illustration in three dimensions (3D) of validated lithology results for a lateral well 500 and its surrounding area. The different nuances of gray in this figure correspond to different materials (i.e., Calc Mudstone, Limestone, Calcareous Silk, Rocks with Low Water Saturation and High Porosity (LSHP), Silk Mudstone).

FIG. 6 is an illustration in 3D of validated P-impedance values for a lateral well 600 and its surrounding area. The different nuances of gray in FIG. 6 correspond to different values in a range of 20-65 kg/cc*ft/s.

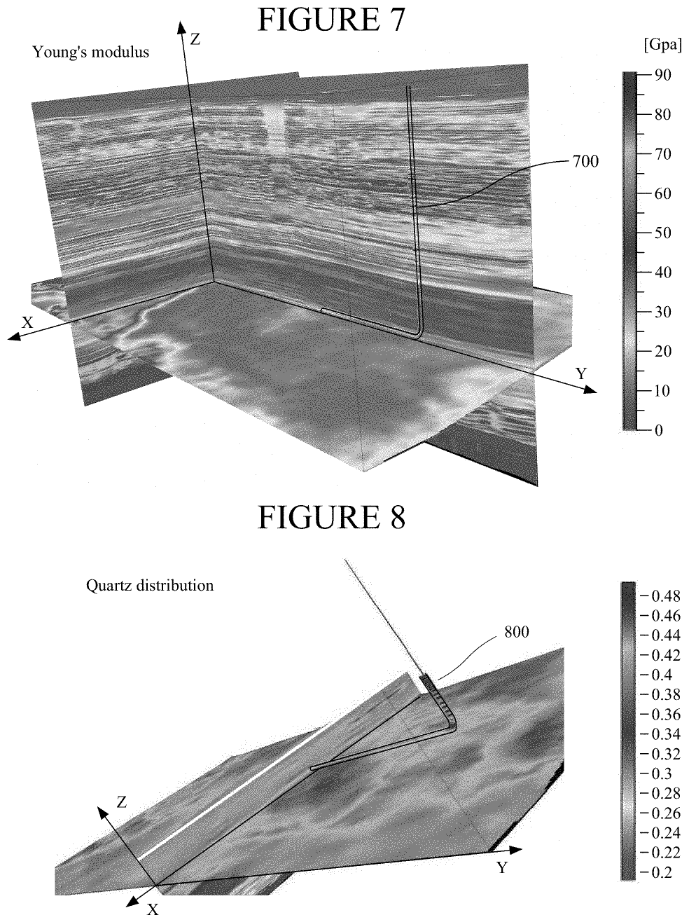

FIG. 7 is an illustration in 3D of validated Young Modulus (YM) values for a lateral well 700 and its surrounding area. The different nuances of gray in FIG. 7 correspond to different YM value ranges up to 90 GPa.

FIG. 8 is an illustration of validated quartz distribution for a lateral well 800 and its surrounding area. The different nuances of gray in FIG. 8 correspond to the variability of the volume of quartz and indicates the heterogeneity of reservoir rock type with values in a range of 0.20-0.48.

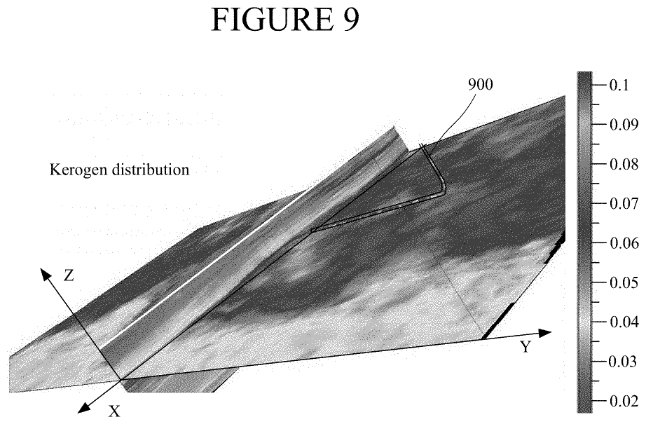

FIG. 9 is an illustration of validated Kerogen distribution for a lateral well and its surrounding area. The different nuances of gray in FIG. 9 correspond to the variability of the naturally occurring, solid, insoluble organic matter that occurs in source rocks and can yield oil upon heating with values in a range of 0.02-0.1.

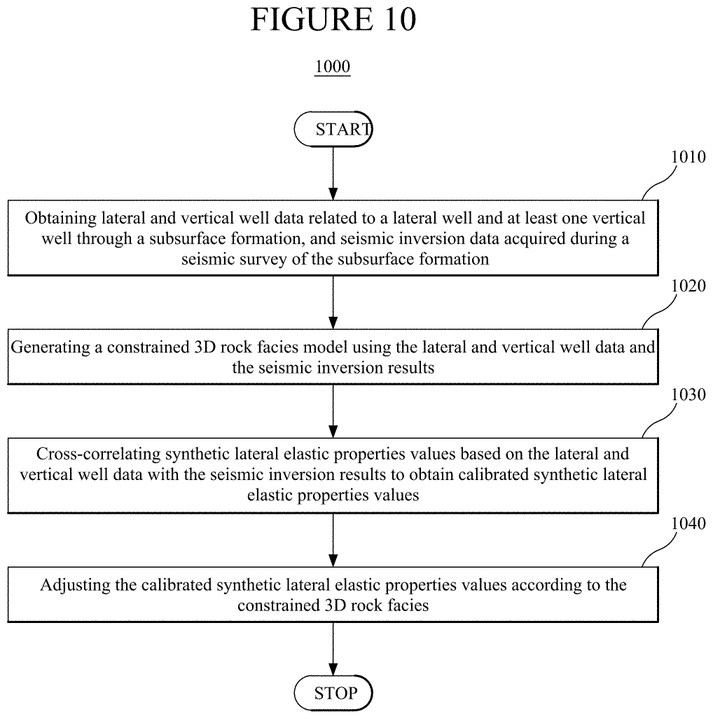

FIG. 10 is a flowchart of a seismic exploration method 1000 according to an embodiment. Method 1000 includes obtaining lateral well data related to a well through a subsurface formation that has been explored using a seismic survey at 1010. Method 1000 further includes using the lateral well data to calibrate and validate synthetic lateral elastic properties values extracted from seismic data acquired during the seismic survey and vertical well log data related to one or more vertical wells drilled in the subsurface formation at 1040. The calibrated and validated lateral elastic properties values are usable in fracking-related decisions (e.g., well completion design and well engineering).

The lateral well data includes one or more of drilling data, geological material data, core cuttings and mechanical behavior parameters. Step 1020 may include deriving a rock physics model and a geological rock facies model from the vertical well log data. Step 1030 may then include using the rock physics model and the lateral well data to generate synthetic lateral elastic properties values for locations along the lateral well. In one embodiment, a set of seismically calibrated synthetic lateral elastic properties values are generated based on results of a seismic inversion applied to the seismic data and the synthetic lateral elastic properties values.

Additionally or alternatively, step 1020 may include generating a vertically calibrated lateral well rock facies model based on the geological rock facies model and the lateral well data

One embodiment of the method also includes:
deriving a rock physics model and a geological rock facies model from the vertical well log data,
using the rock physics model and the lateral well data to generate synthetic lateral elastic properties values for locations along the lateral well;
generating a set of seismically calibrated synthetic lateral elastic properties values based on results of a seismic inversion applied to the seismic data and the synthetic lateral elastic properties values,
generating a vertically calibrated lateral well rock facies model based on the geological rock facies model and the lateral well data,
deriving a constrained rock facies model from the vertically calibrated lateral well rock facies model, results of a seismic inversion applied to the seismic data and the geological rock facies model,
obtaining the calibrated and validated synthetic lateral elastic properties values by adjusting the seismically calibrated synthetic lateral elastic property values to match the constrained rock facies model.

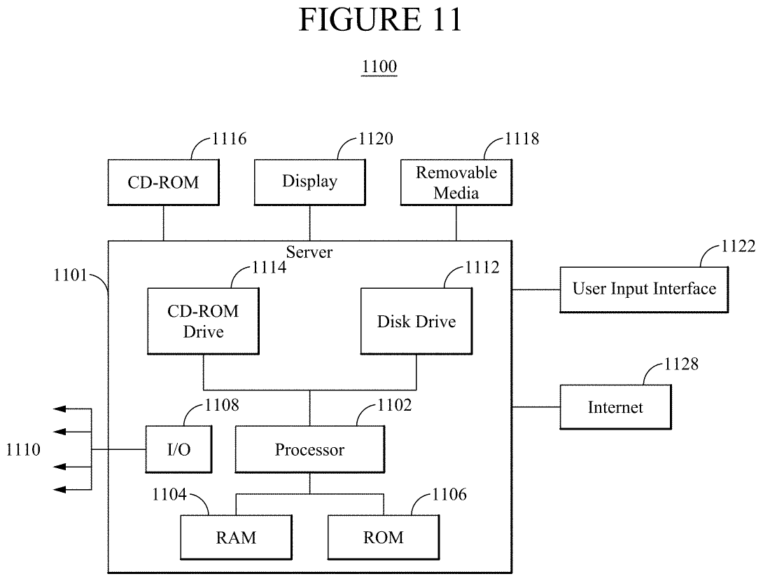

The above-discussed methods may be implemented in a computing device 1100 as illustrated in FIG. 11. Hardware, firmware, software or a combination thereof may be used to perform the various steps and operations described herein.

Exemplary computing device 1100 suitable for performing the activities described in the exemplary embodiments may include a server 1101. Server 1101 may include a central processor (CPU) 1102 coupled to a random-access memory (RAM) 1104 and to a read-only memory (ROM) 1106. ROM 1106 may also be other types of storage media to store programs, such as programmable ROM (PROM), erasable PROM (EPROM), etc. Processor 1102 may communicate with other internal and external components through input/output (I/O) circuitry 1108 and bussing 1110 to provide control signals and the like. Processor 1102 carries out a variety of functions as are known in the art, as dictated by software and/or firmware instructions.

Server 1101 may also include one or more data storage devices, including hard drives 1112, CD-ROM drives 1114 and other hardware capable of reading and/or storing information, such as DVD, etc. In one embodiment, software for carrying out the above-discussed steps may be stored and distributed on a CD-ROM or DVD 1116, a USB storage device 1118 or other form of media capable of portably storing information. These storage media may be inserted into, and read by, devices such as CD-ROM drive 1114, disk drive 1112, etc. Server 1101 may be coupled to a display 1120, which may be any type of known display or presentation screen, such as LCD, plasma display, cathode ray tube (CRT), etc. A user input interface 1122 is provided, including one or more user interface mechanisms such as a mouse, keyboard, microphone, touchpad, touch screen, voice-recognition system, etc.

Server 1101 may be coupled to other devices, such as sources, detectors, etc. The server may be part of a larger network configuration as in a global area network (GAN) such as the internet 1128, which allows ultimate connection to various computing devices.

According to one embodiment, I/O circuitry 1108 is configured to obtain lateral well data related to a well through a subsurface formation that has been explored using a seismic survey (e.g., this circuitry may be connected to data collection equipment), and processor 1102 is configured to use the lateral well data to calibrate and validate lateral elastic properties values extracted from seismic data acquired during the seismic survey and vertical well log data related to one or more vertical wells drilled in the subsurface formation.

In yet another embodiment, RAM 1104 stores executable codes that, when executed make the I/O circuitry 1108 to obtain lateral well data related to a well through a subsurface formation that has been explored using a seismic survey (e.g., this circuitry may be connected to data collection equipment), and processor 1102 to use the lateral well data to calibrate and validate lateral elastic properties values extracted from seismic data acquired during the seismic survey and vertical well log data related to one or more vertical wells drilled in the subsurface formation.

The disclosed embodiments provide methods and devices for validating lateral elastic properties values extracted from seismic data acquired during the seismic survey and vertical well log data related to one or more vertical wells drilled in the subsurface formation, using lateral well data. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein. The methods or flowcharts provided in the present application may be implemented in a computer program, software or firmware tangibly embodied in a computer-readable storage medium for execution by a general-purpose computer or a processor.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A seismic exploration method comprising:
obtaining lateral and vertical well data related to a lateral well and at least one vertical well through a subsurface formation, and seismic inversion results for seismic data acquired during a seismic survey over the subsurface formation;
generating a constrained 3D rock facies model using the lateral and vertical well data and the seismic inversion results;
cross-correlating synthetic lateral elastic properties values for locations along the lateral well, based on the lateral and vertical well data with the seismic inversion results to obtain calibrated synthetic lateral elastic properties values; and
adjusting the calibrated synthetic lateral elastic properties values according to the constrained 3D rock facies model,
wherein the calibrated lateral elastic properties values validated by matching the constrained 3D rock facies model are usable in fracking-related decisions.

2. The method of claim 1, wherein the lateral well data includes one or more of drilling data, geological material data, core cuttings and mechanical behavior parameters.

3. The method of claim 1, further comprising:
deriving a rock physics model and a geological rock facies model from the vertical well data for locations along the lateral well.

4. The method of claim 3, further comprising:
using the rock physics model and the lateral well data to generate the synthetic lateral elastic properties values.

5. The method of claim 3, the generating of the constrained 3D rock facies model includes generating a vertically calibrated lateral well rock facies model based on the geological rock facies model and the lateral well data.

6. The method of claim 1, further comprising extrapolating the lateral well data into two and/or three dimensions.

7. The method of claim 1, further comprising:
deriving a rock physics model and a geological rock facies model from the vertical well data;
using the rock physics model and the lateral well data to generate synthetic lateral elastic properties values for locations along the lateral well; and
generating a vertically calibrated lateral well rock facies model based on the geological rock facies model and the lateral well data.

8. A seismic data processing apparatus, comprising:
an interface configured to obtain lateral and vertical well data related to lateral and vertical wells through a subsurface formation, and seismic inversion results for seismic data acquired during a seismic survey over the subsurface formation; and
a data processing unit connected to the interface and configured
to generate a constrained 3D rock facies model using the lateral and vertical well data and the seismic inversion results,
to cross-correlate synthetic lateral elastic properties values based on the lateral and vertical well data with the seismic inversion results to obtain calibrated synthetic lateral elastic properties values, and
to adjust the calibrated synthetic lateral elastic properties values according to the constrained 3D rock facies model,
wherein the calibrated lateral elastic properties values validated by matching the constrained 3D rock facies model are usable in fracking-related decisions.

9. The apparatus of claim 8, wherein the lateral well data includes one or more of drilling data, geological material data, core cuttings and mechanical behavior parameters.

10. The apparatus of claim 8, wherein the data processing unit derives a rock physics model and a geological rock facies model from the vertical well data.

11. The apparatus of claim 10, wherein the data processing unit uses the rock physics model and the lateral well data to generate the synthetic lateral elastic properties values.

12. The apparatus of claim 10, wherein the data processing unit generates a vertically calibrated lateral well rock facies model based on the geological rock facies model and the lateral well data, the vertically calibrated lateral well rock facies model being then used to generate the constrained 3D rock facies model.

13. The apparatus of claim 8, wherein the data processing unit extrapolates the lateral well data into two and/or three dimensions.

14. The apparatus of claim 8, the data processing unit is further configured to derive a rock physics model and a geological rock facies model from the vertical well log data,
to use the rock physics model and the lateral well data to generate the synthetic lateral elastic properties values, and
to generate a vertically calibrated lateral well rock facies model based on the geological rock facies model and the lateral well data, the vertically calibrated lateral well rock facies model being then used to generate the constrained 3D rock facies model.

15. A computer readable medium storing executable codes that, when executed by a computer make the computer perform a seismic exploration method comprising:
obtaining lateral and vertical well data related to a lateral well and at least one vertical well through a subsurface formation, and seismic inversion results for seismic data acquired during a seismic survey over the subsurface formation;
generating a constrained 3D rock facies model using the lateral and vertical well data and the seismic inversion results;
cross-correlating synthetic lateral elastic properties values for locations along the lateral well, based on the lateral and vertical well data with the seismic inversion results to obtain calibrated synthetic lateral elastic properties values; and
adjusting the calibrated synthetic lateral elastic properties values according to the constrained 3D rock facies model,
wherein the calibrated lateral elastic properties values validated by matching the constrained 3D rock facies model are usable in fracking-related decisions.

16. The computer readable medium of claim 15, wherein the method further comprises deriving a rock physics model and a geological rock facies model from the vertical well data for locations along the lateral well.

17. The computer readable medium of claim 16, wherein the method further comprises using the rock physics model and the lateral well data to generate the synthetic lateral elastic properties values.

18. The computer readable medium of claim 16, wherein the method further comprises generating a vertically calibrated lateral well rock facies model based on the geological rock facies model and the lateral well data.

19. The computer readable medium of claim 15, wherein the method further comprises extrapolating the lateral well data into two and/or three dimensions.

20. The computer readable medium of claim 15, wherein the method further comprises:
deriving a rock physics model and a geological rock facies model from the vertical well data;
using the rock physics model and the lateral well data to generate synthetic lateral elastic properties values for locations along the lateral well; and
generating a vertically calibrated lateral well rock facies model based on the geological rock facies model and the lateral well data.
